(19) United States
(12) Patent Application Publication
(10) Pub. No.: US 2017/0228987 A1
(43) Pub. Date: Aug. 10, 2017

(54) POKER GAME MACHINE AND METHOD AND SYSTEM FOR PLAYING POKER GAMES

(71) Applicant: Sheng-Huo Cheng, Taichung City (TW)

(72) Inventor: Sheng-Huo Cheng, Taichung City (TW)

(21) Appl. No.: 15/016,291

(22) Filed: Feb. 5, 2016

(51) Int. Cl. G07F 17/32

(52) U.S. Cl. CPC G07F 17/3293; G07F 17/3211

(57) ABSTRACT

A game machine of pokers includes a table, and a surface of the table including a first royal flush section, a second royal flush section, a five of a kind section, a straight flush section, a four of a kind section, a full house section, a flush section, a straight section, a three of a kind section, a two pairs section, a one pair section, a separate section, and other sections. a counting unit installed on the table for receiving suits and points of five pokers presented on the surface of the table; the counting unit presenting the odds for the different sections on a screen based on the suits and points of the five pokers; and the odds being adjustable according to the open of the pokers in different boards. A method and system for playing game are also included.

### FIELD OF THE INVENTION

The present invention relates to poker games, and in particular to poker game machine and the method and system for playing a poker game.

### BACKGORUND OF THE INVENTION

Poker games are leisure activities through using pokers of different colors and points. Various pokers games are developed by setting different rules. Currently, there rules are more and more complicated and skillful.

Other then the rules for poker games, in recent applications, hardware, such as tables, and other auxiliary tools are limited so as to confine variety of the poker games. For example, only one table is used for placing the pokers and coins. Dealing and wagers are performed on the table. The table is a fixed structure and does not play a role in the playing of games. However, if the table is changed to play a role in the game, the whole process in playing game will become more and more interest and vivid.

### SUMMARY OF THE INVENTION

Accordingly, the object of the present invention is to provide a game, a table and a computer system machine, wherein by the game, table or computer system of the present invention, the odds are presented when only some of the pokers are dealt so as to increase interest in playing the game.

To achieve above object, the present invention provides a game-machine of pokers comprising a table, and a surface of the table including a first royal flush section, a second royal flush section, a five of a kind section, a straight flush section a four of a kind section, a full house section, a flush section, a straight section, a three of a kind section, a two pairs section, a one pair section, a separate section, and other sections; and a counting unit installed on the table for receiving suits and points of five pokers presented on the surface of the table; the counting unit presenting odds for the different sections on a screen based on the suits and points of the five pokers; and the odds being adjustable according to the open of the pokers in different boards.

Furthermore, the present invention provides a method for playing a poker game, in that one dealer and several player playing the poker game by using a table defining in claim 1, the method comprise the steps of: a plurality of chips with a specific color for identifying the players in betting; wherein a set of pokers including 52 cards being used in dealing; in each board, seven cards being dealt; the earlier five cards facing upwards; then the other two cards being dealt with faces downwards; the players starting to bet by selecting a section from the sections on the table; after the former five pokers being dealt with faces upwards and then suits and points of the five pokers being inputted to the counting unit; the respective odds in each section being shown on the screen on the table; and then the other two pokers facing downwards being turned upwards, an optimum poker assembly of five poker cards having a greatest possibility for winning at a board of five cards is selected from the seven pokers and is used as a base for deciding a section which optimum poker assembly is belonged to.

Moreover, the present invention provides a poker game computer system comprising: a plurality of bet terminals; each bet terminal being connected to a dedicated screen; the screen can display a plurality of sections, including: a first royal flush section, a second royal flush section, a five of a kind section, a straight flush section, a four of a kind section, a full house section, a flush section, a straight section, a three of a kind section, a two pairs section, a one pair section, a separate section, etc.; and a dealer terminal including a console which is connected to all the bet terminals; the console being built with a deal process by present the steps of the process on a screen of the console: wherein in the process, by displaying on a screen of the console, at first, seven cards are dealt; the earlier five cards are faced upwards; then the other two cards are dealt with faces downwards; the respective odds in each section are presented; then the players start to bet on the sections; then the other two pokers are turned upwards; the deal program selects a poker assembly of five pokers from the seven pokers to have an optimum assembly for determining which section comply an optimum assembly for winning the game; and each time only a section is matched to the optimum assembly.

### BRIEF DESCRIPTION OF THE DRAWINGS

FIG. 1 shows a schematic view showing the distribution of the able and gamers.

FIGS. 2A and 2L show the bet sections of the present invention.

FIG. 3 is a flow chart about the process of the present invention.

FIG. 4 is a schematic view includes the system of the present invention.

FIGS. 5A to 5L show the bet section in the system of the present invention.

FIG. 6 is a schematic view showing the open of the poker cards according to the present invention.

FIG. 7 is a schematic view showing the display of odds according to the present invention.

FIG. 8 is a schematic view showing one display way according to the present invention.

FIG. 9 is a schematic view showing the optimum poker assembly in one example of the present invention.

### DETAILED DESCRIPTION OF THE INVENTION

In order that those skilled in the art can further understand the present invention, a description will be provided in the following in details.

However, these descriptions and the appended drawings are only used to cause those skilled in the art to understand the objects, features, and characteristics of the present invention, but not to be used to confine the scope and spirit of the present invention defined in the appended claims.

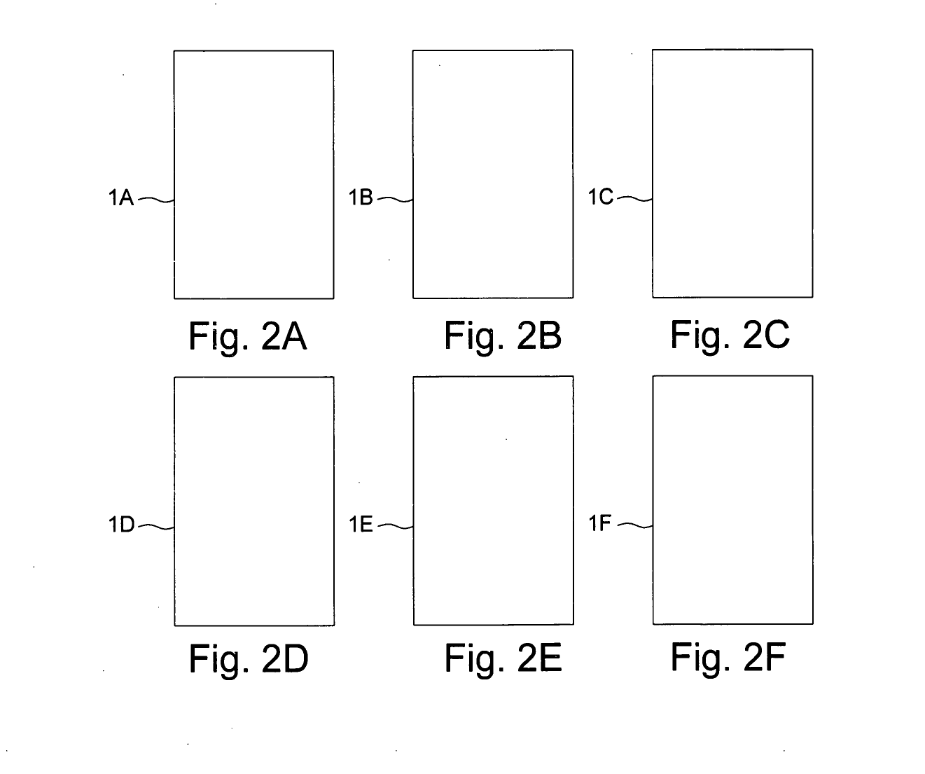

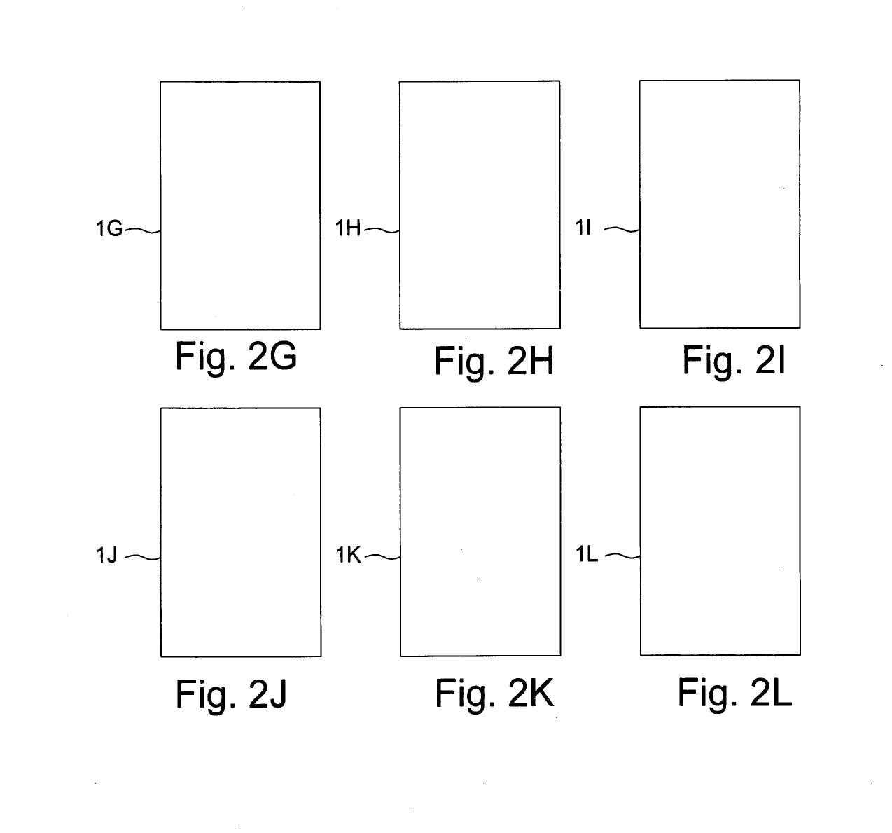

A game machine of pokers of the present invention is illustrated in FIGS. 2A to 2L. The game machine includes a table 1. A surface of the table includes a first royal flush section 1A, a second royal flush section 1B, a five of a kind section 1C, a straight flush section 1D, a four of a kind section 1E, a full house section 1F, a flush section 1G, a straight section 1H, a three of a kind section 1I, a two pairs section 1J, a one pair section 1K, a separate section 1L, etc. A surface of the table 1 is installed with a counting unit 13 After five pokers are presented on the table surface of the table 1, the suits and points (number of the poker card) of the five pokers are inputted into the counting unit 13 and then the counting unit 13 will present the odds for the different sections 1A to 1L on a screen 14. Garners could select the ways for betting (the higher the odds, the lower the possibility of presenting the specific poker sequences defined in sections 1A to 1L, and moreover, the odds are adjustable according to the open of the pokers in different boards so as to increase the interest in gaming).

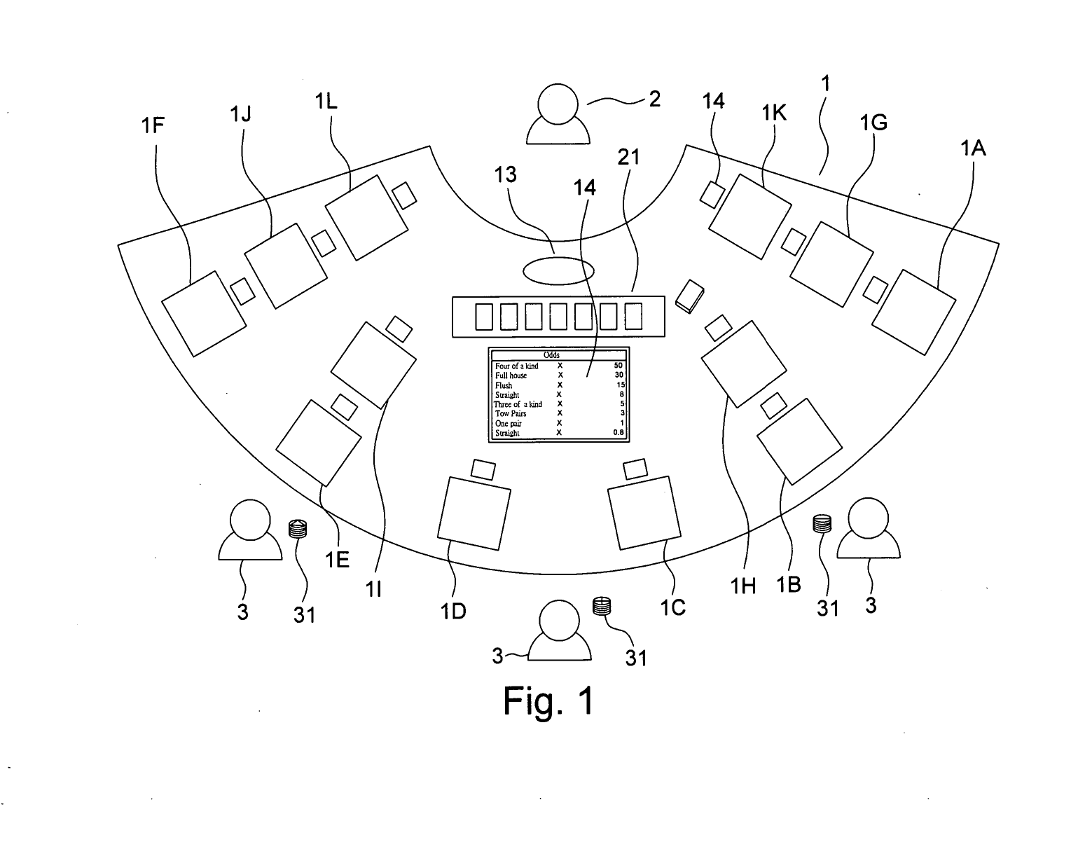

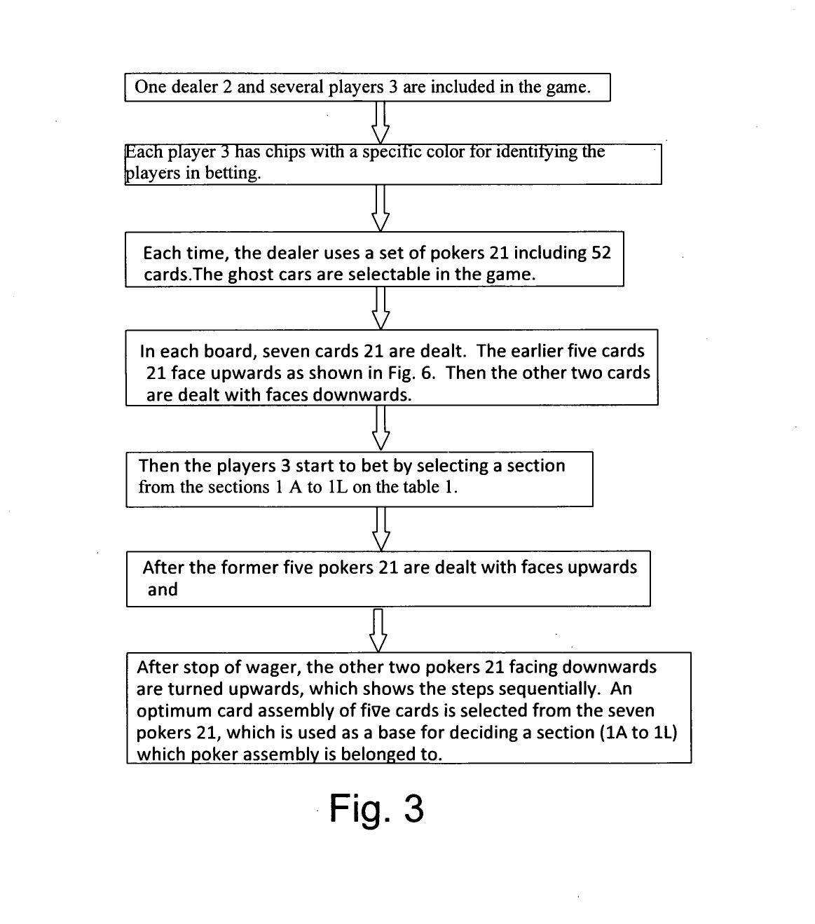

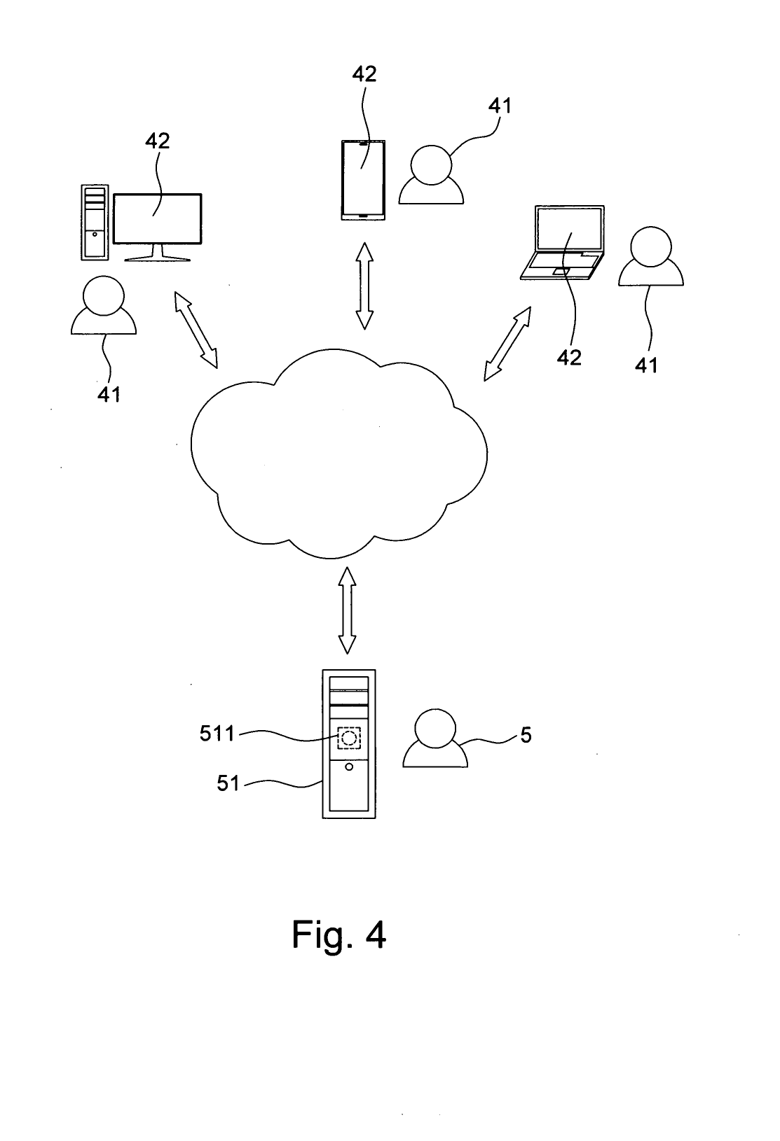

An embodiment about the use of the poker game machine of the present invention is illustrated the process of FIG. 3 with reference to FIG. 1. The game includes the following steps:

1. One dealer 2 and several players 3 are included in the game.

2. Each player 3 has chips with a specific color for identifying the players in betting.

3. Each time, the dealer uses a set of pokers 21 including 52 cards. The ghost cars are selectable in the game. For example, two ghost cards are used so as to expand the card number from 52 to 54, each being designated with a suit and a point as desired by the gamer holding the cards. As a result, there are more kinds of odds and more, sections above defined may be used in the gaming. For example, the adding of ghost cards may increase the probabilities for generating straight flush and straight so that the first royal flush section 1A, second royal flush section 1B, straight section 1C have higher possibilities to be used in the game.

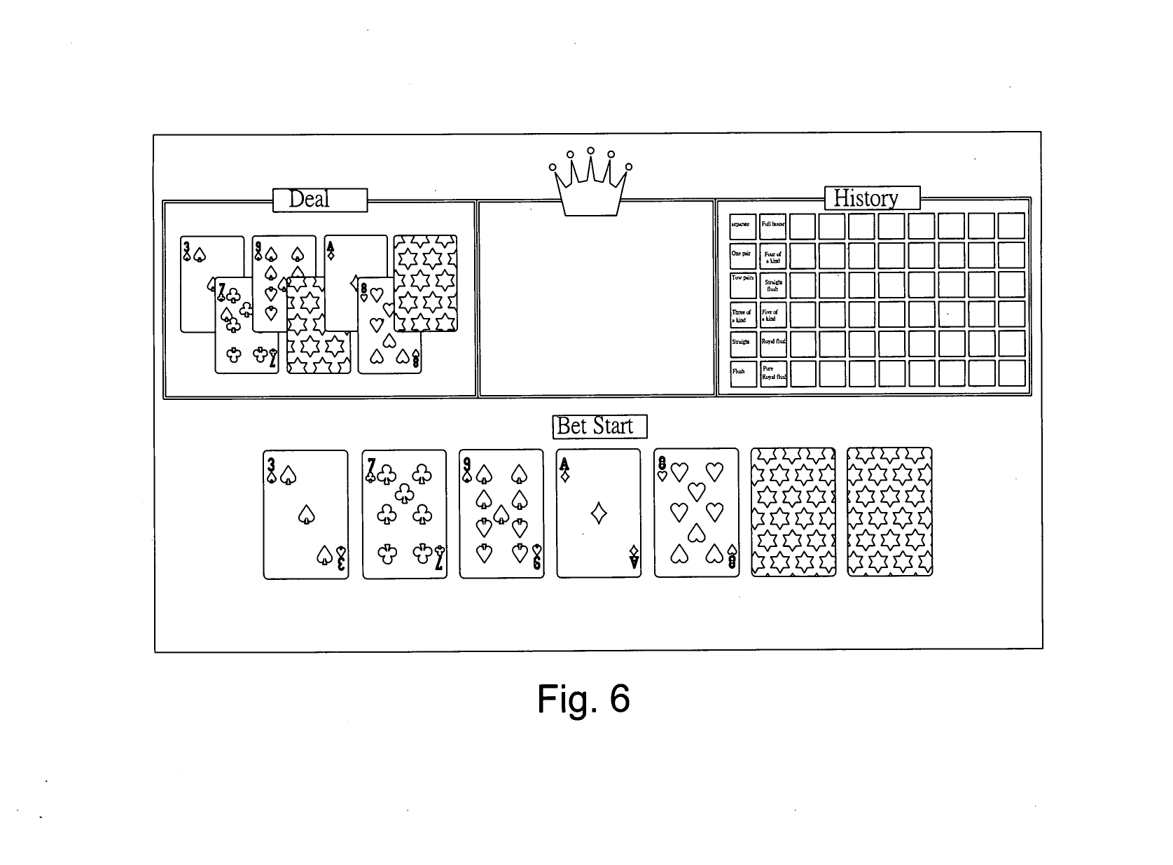

4. In each board, seven cards 21 are dealt. The earlier five cards 21 face upwards as shown in FIG. 6. Then the other two cards are dealt with faces downwards.

5. Then the players 3 start to bet by selecting a section from the sections 1 A to 1L on the table 1.

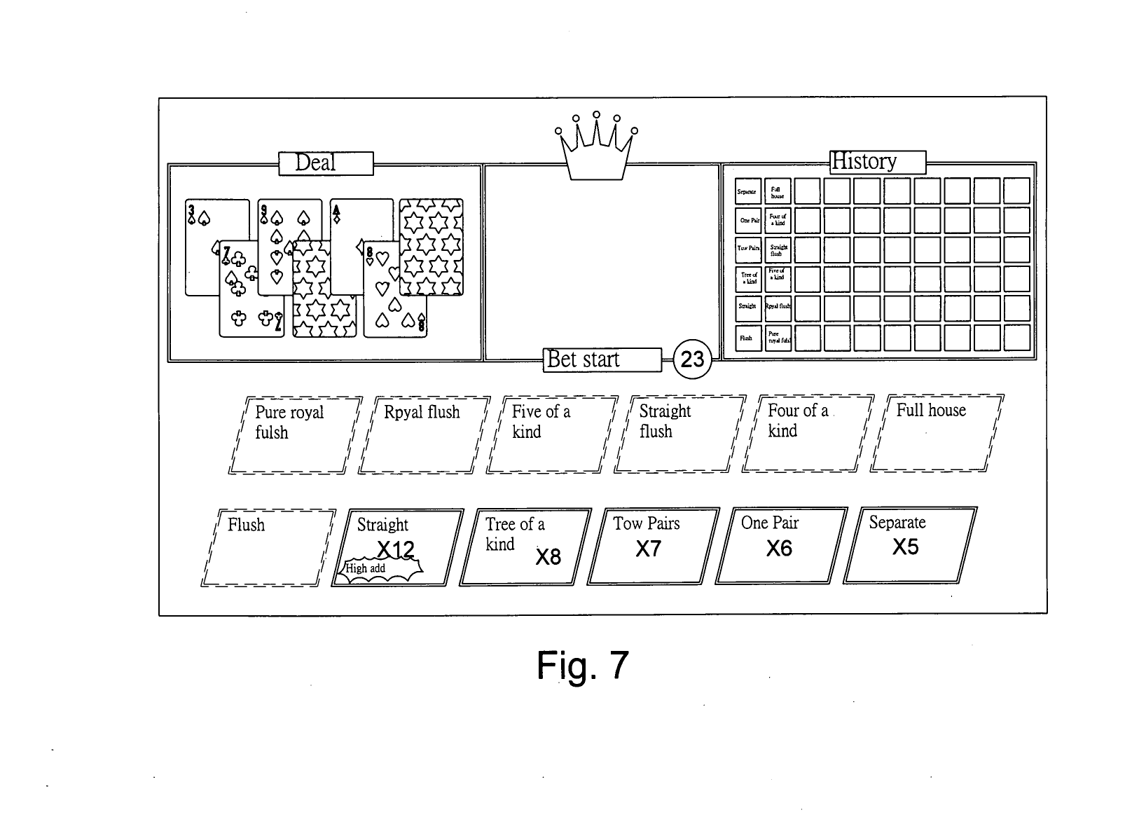

6. After the former five pokers 21 are dealt with faces upwards and then the suits and points of the five pokers 21 are inputted to the counting unit 13. The respective odds in each section 1A to 1L are shown on the screen 14 as illustrated in FIG. 7 of the present invention.

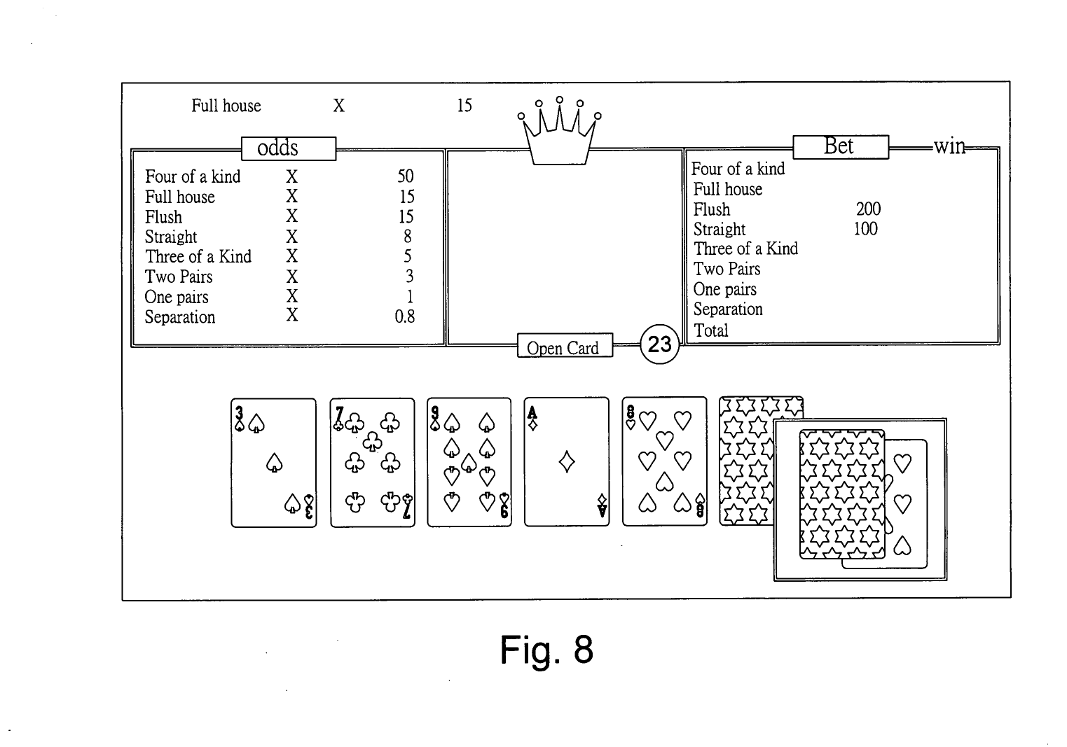

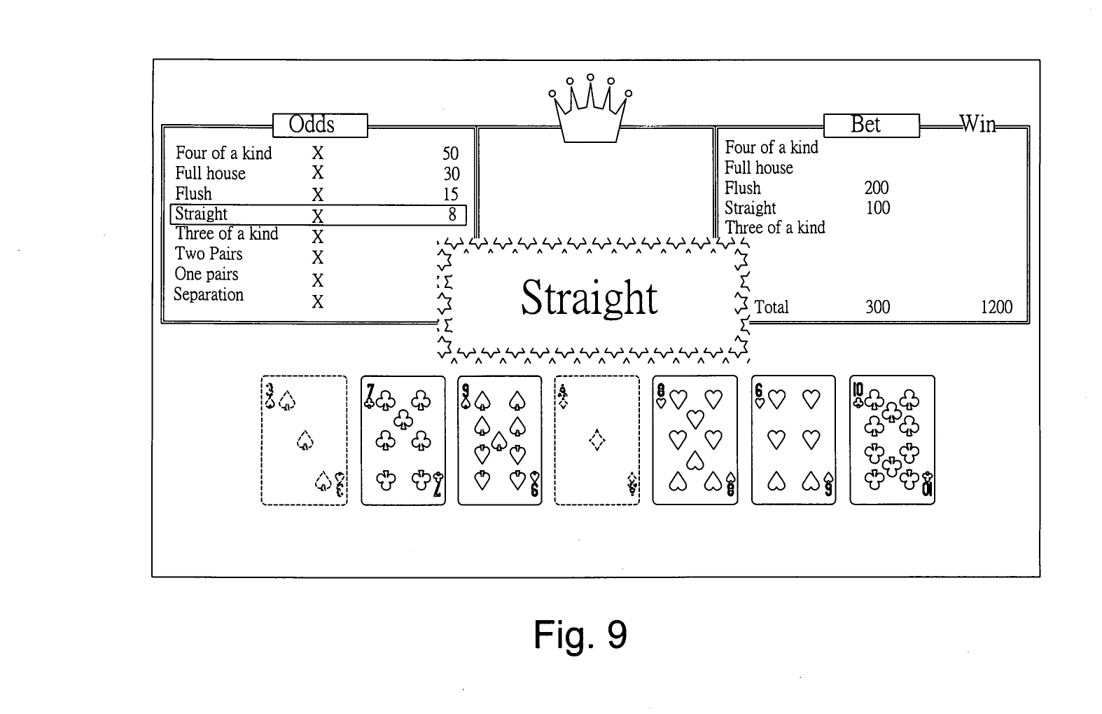

7. After stop of wager, the other two pokers 21 facing downwards are turned upwards as shown in FIG. 8, which shows the steps sequentially. An optimum card assembly (which has a greatest possibility for winning at the board) of five cards is selected from the seven pokers 21 as illustrated in FIG. 9, which is used as a base for deciding a section (1A to 1L) which poker assembly is belonged to.

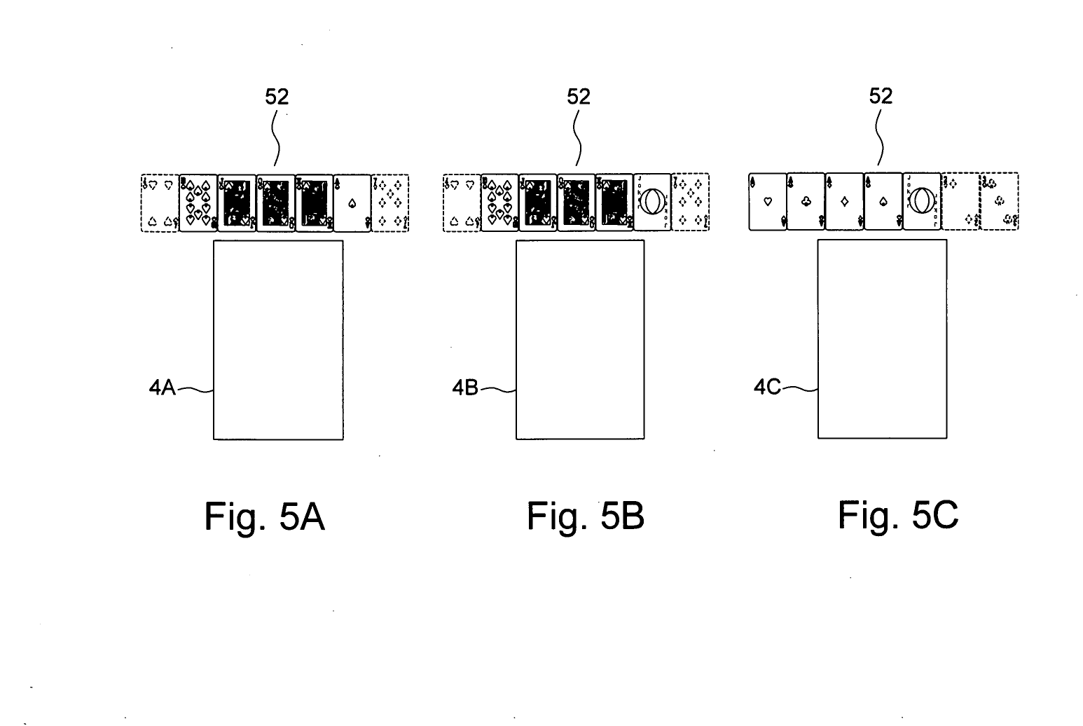

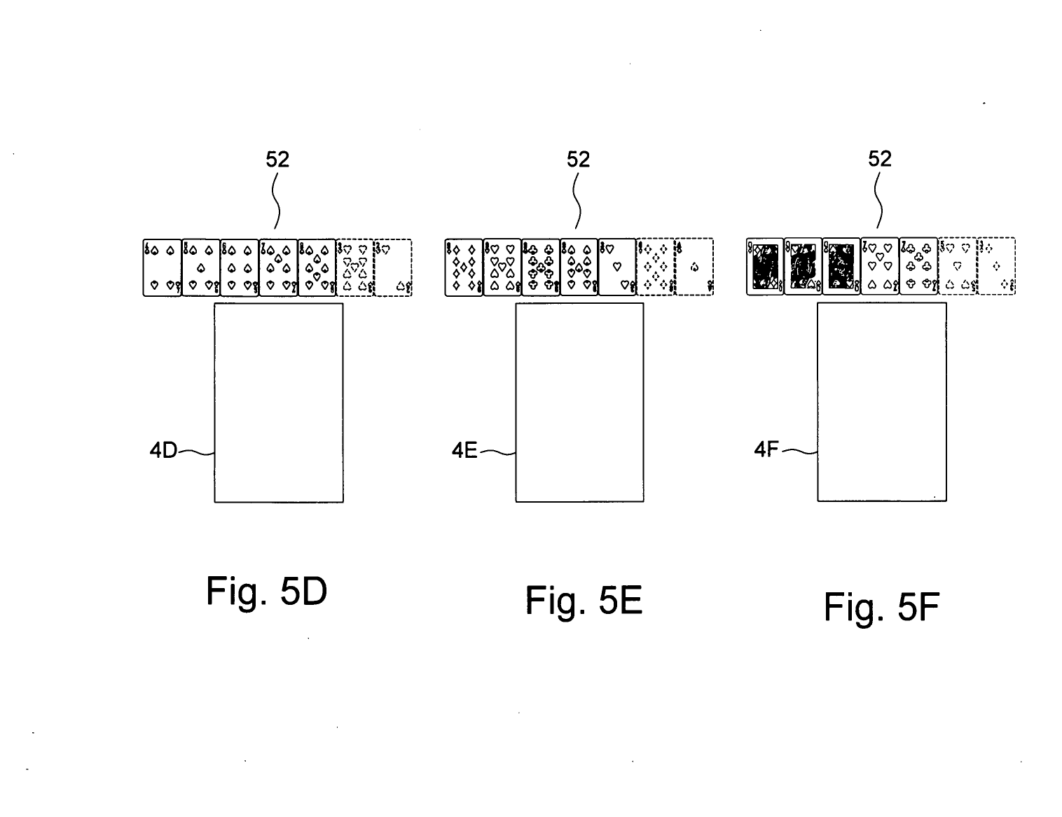

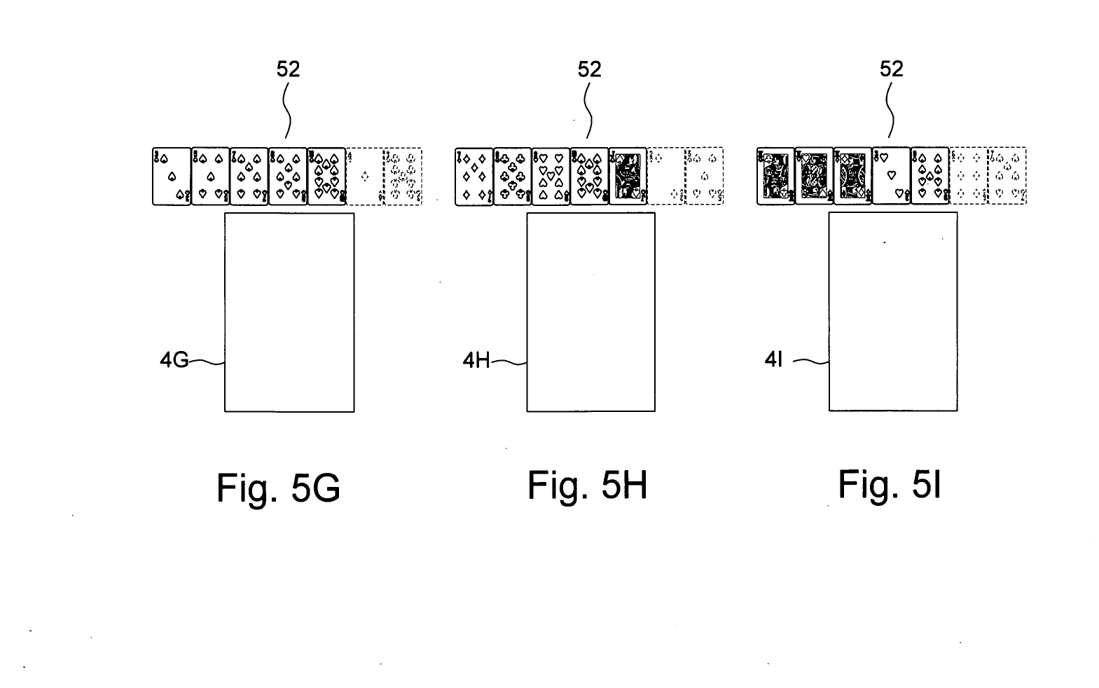

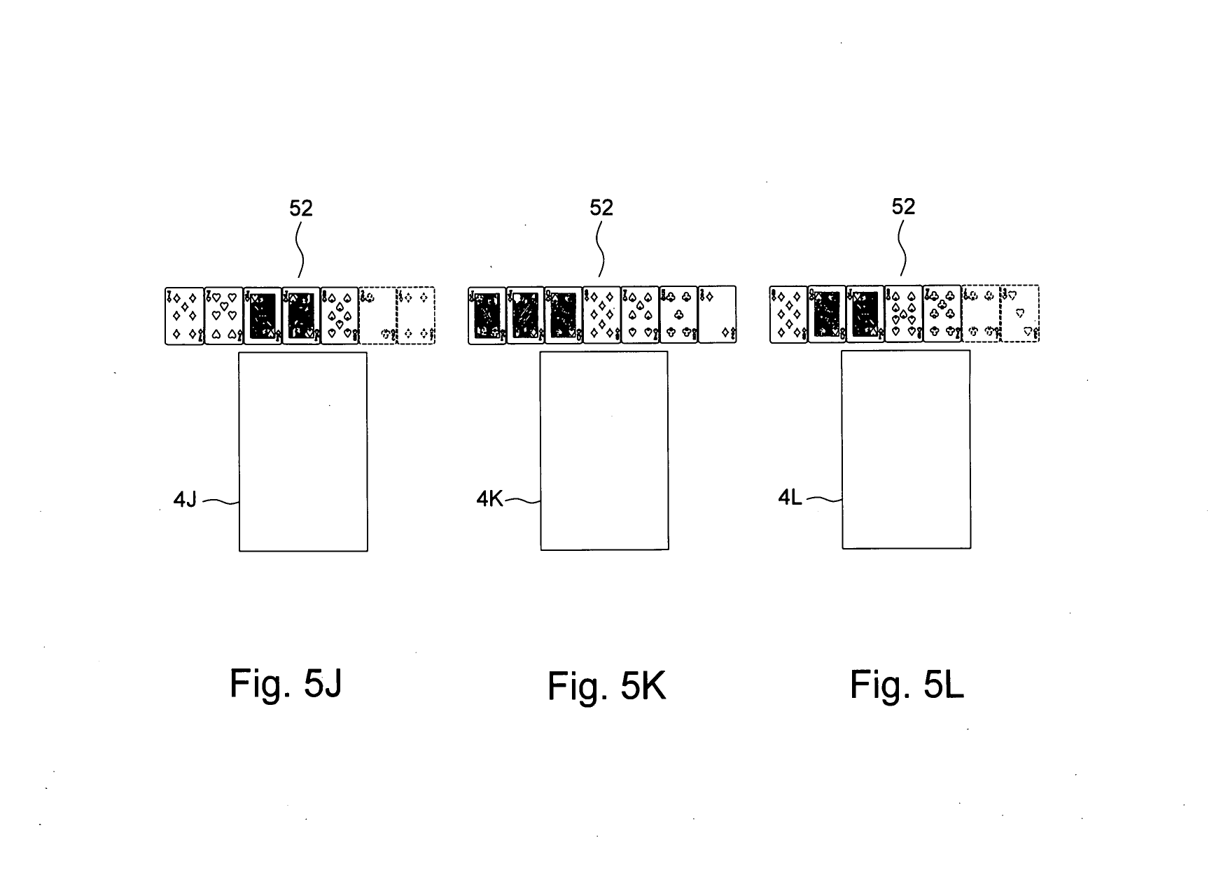

In another embodiment, the present invention can be realized by a computer system, as illustrated in FIGS. 5A to 5L. The system includes the following elements.

A plurality of bet terminals 41 are included. Each bet terminal 41 is connected to a dedicated screen 42 as shown in FIG. 5. The screen 42 could display a plurality of sections, including: a first royal flush section 4A, a second royal flush section 4B, a five of a kind section 4C, a straight flush section 4D, a four of a kind section 4E, a full house section 4F, a flush section 4G, a straight section 4H, a three of a kind section 4I, a two pairs section 4J, a one pair section 4K, a separate section 4L, etc.

A dealer terminal 5 includes a console 51 which is connected to all the bet terminals 41. The console 51 is built with a deal program 511 by which it is shown that: at each board, seven cards 52 are dealt. The earlier five cards 52 are faced upwards. Then the other two cards 52 are dealt with faces downwards. The respective odds in each section 4A to 4L are presented. Then the players 3 start to bet on the sections 4A to 4L. Then the other two pokers 52 are turned upwards. The deal program 511 selects a poker assembly of five pokers 52 from the seven pokers 52 to have an optimum assembly for determining which section comply an optimum assembly for wining the game. Each time only a section (5A to 5L) is matched to the optimum assembly.

By the game, table or computer system of the present invention, the odds are presented when only some of the pokers are dealt so as to increase interest in playing the game.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A game machine of pokers comprising
a table, and a surface of the table including a first royal flush section, a second royal flush section, a five of a kind section, a straight flush section, a four of a kind section, a full house section, a flush section, a straight section, a three of a kind section, a two pairs section, a one pair section, a separate section, and other sections; and
a counting unit installed on the table for receiving suits and points of five pokers presented on the surface of the table; the counting unit presenting odds for the different sections on a screen based on the suits and points of the five pokers; and the odds being adjustable according to the open of the pokers in different boards.

2. A method for playing a poker game, in that one dealer and several player playing the poker game by using a table defining in claim 1, the method comprise the steps of:
a plurality of chips with a specific color for identifying the players in betting; wherein a set of pokers including 52 cards being used in dealing;
in each board, seven cards being dealt; the earlier five cards facing upwards; then the other two cards being dealt with faces downwards;
the players starting to bet by selecting a section from the sections on the table;
after the former five pokers being dealt with faces upwards and then suits and points of the five pokers being inputted to the counting unit; the respective odds in each section being shown on the screen on the table; and
then the other two pokers facing downwards being turned upwards, an optimum poker assembly of five poker cards having a greatest possibility for winning at a board of five cards is selected from the seven pokers and is used as a base for deciding a section which optimum poker assembly is belonged to.

3. The method of claim 2, wherein ghost cards are selectable in the game; as the ghost cards are used, each is designated with a suit and a number as desired by the gamer holding the ghost cards; ghost cards may increase the probabilities for generating straight flush and straight.

4. A poker game computer system comprising:
a plurality of bet terminals; each bet terminal being connected to a dedicated screen; the screen can display a plurality of sections, including: a first royal flush section, a second royal flush section, a five of a kind section, a straight flush section, a four of a kind section, a full house section, a flush section, a straight section, a three of a kind section, a two pairs section, a one pair section, a separate section, etc.; and
a dealer terminal including a console which is connected to all the bet terminals; the console being built with a deal process by present the steps of the process on a screen of the console:
wherein in the process, by displaying on a screen of the console, at first, seven cards are dealt; the earlier five cards are faced upwards; then the other two cards are dealt with faces downwards; the respective odds in each section are presented; then the players start to bet on the sections; then the other two pokers are turned upwards; the deal program selects a poker assembly of five pokers from the seven pokers to have an optimum assembly for determining which section comply an optimum assembly for winning the game; and each time only a section is matched to the optimum assembly.
